(19) United States
(12) Patent Application Publication
(10) Pub. No.: US 2026/0086620 A1
(43) Pub. Date: Mar. 26, 2026

(54) NETWORK SYSTEM

(71) Applicant: DENSO CORPORATION, Kariya-city (JP)

(72) Inventors: Yuki FUKUSHIMA, Kariya-city (JP); Tomohisa KISHIGAMI, Kariya-city (JP)

(21) Appl. No.: 19/335,015

(22) Filed: Sep. 22, 2025

(30) Foreign Application Priority Data
Sep. 24, 2024 (JP) 2024-165366

(51) Int. Cl. G06F 1/3234

(52) U.S. Cl. CPC G06F 1/3234

(57) ABSTRACT

A network system switches a power supply between a high power state and a low power state. The network system includes a first ECU communicably connected to terminal devices and a second ECU communicably connected to the first ECU. The first ECU includes: a power switching circuit configured to switch a power supply to the second ECU between a power supply state and a power cutoff state; an off control circuit configured to, using the power switching circuit, switch the power supply to the second ECU from the power supply state to the power cutoff state in response to an instruction; and an on control circuit configured to, using the power switching circuit, switch the power supply to the second ECU from the power cutoff state to the power supply state in response to an instruction.

### CROSS REFERENCE TO RELATED APPLICATION

The present application claims the benefit of priority from Japanese Patent Application No. 2024-165366 filed on Sep. 24, 2024. The entire disclosure of the above application is incorporated herein by reference.

### TECHNICAL FIELD

The present disclosure relates to a technique for reducing power consumption in a network system.

### BACKGROUND

Usually, a vehicle is equipped with a large number of electronic control units (ECUs) for controlling in-vehicle devices. A network system including ECUs as nodes is constructed by connecting the multiple ECUs to a communication bus.

As a known related art, a partial network reduces power consumption of the entire network system by setting a sleep state which stops functions of some ECUs that are not necessary for control operation according to a situation.

### SUMMARY

According to an aspect of the present disclosure, a network system switches a state of a system, which is supplied with power from a power source, between a high power state and a low power state. The network system includes a first electronic control unit communicably connected to one or more terminal devices and configured to control an operation of each terminal device, and a second electronic control unit communicably connected to the first electronic control unit and configured to control an operation of the first electronic control unit. The first electronic control unit includes a power switching circuit, an OFF control circuit, and an ON control circuit. The power switching circuit may be configured to switch a power supply to the second electronic control unit between a power supply state in which the power supply to the second electronic control unit is activated and a power cutoff state in which the power supply to the second electronic control unit is deactivated. The OFF control circuit may be configured to, using the power switching circuit, switch the power supply to the second electronic control unit from the power supply state to the power cutoff state in response to receiving an instruction to shift to an OFF mode indicating switching from the high power state to the low power state. The ON control circuit may be configured to, using the power switching circuit, switch the power supply to the second electronic control unit from the power cutoff state to the power supply state in response to receiving an instruction to shift to an ON mode indicating switching from the low power state to the high power state.

### BRIEF DESCRIPTION OF DRAWINGS

The present disclosure will become apparent from the following detailed description made with reference to the accompanying drawings. In the drawings:

FIG. 1 is a block diagram illustrating an overall configuration of a network system according to a first embodiment;

FIG. 2 is a diagram illustrating a configuration of a specific ZC according to the first embodiment;

FIG. 3 is a block diagram schematically illustrating a hardware configuration of each configuration of the network system according to the first embodiment;

FIG. 4 is a sequence diagram illustrating an operation procedure of the network system according to the first embodiment;

FIG. 5 is a diagram collectively illustrating the operation procedure of the network system according to the first embodiment;

FIG. 6 is a flowchart illustrating an operation at the start of a long period OFF mode according to the first embodiment;

FIG. 7 is a flowchart illustrating an operation at the end of the long period OFF mode according to the first embodiment; and

FIG. 8 is a block diagram illustrating a configuration of a network system according to a second embodiment.

### DETAILED DESCRIPTION

In the above-described related art, as a result of detailed study by the inventors of the present disclosure, the following difficulties are found.

For example, a system is conceivable in which functions for controlling an operation of the entire network system are aggregated in a high-performance ECU (that is, HPC), an ECU is provided in the vicinity of a control target, and a hub ECU (for example, a zone ECU or a domain ECU) that is controlled by the HPC and controls a predetermined group of ECUs is provided. In such a system, in view of an activation speed of the network system, it is conceivable to always turn on power supply to the HPC and the hub ECU located on an upstream side as a power supply path, and perform on-off control of the power supply path only for the ECU located on a downstream side.

However, in the case of such control, since a dark current of the HPC or the hub ECU located on the upstream side cannot be limited, it is difficult to sufficiently reduce the power consumption.

According to an aspect of the present disclosure, a network system switches a state of a system, which is supplied with power from a power source, between a high power state and a low power state. A power consumption in high power state is larger than a power consumption in low power state. The network system includes a first electronic control unit communicably connected to one or more terminal devices and configured to control an operation of each terminal device, and a second electronic control unit communicably connected to the first electronic control unit and configured to control an operation of the first electronic control unit. The first electronic control unit includes a power switching circuit, an OFF control circuit, and an ON control circuit. The power switching circuit is configured to switch a power supply to the second electronic control unit between a power supply state in which the power supply to the second electronic control unit is activated and a power cutoff state in which the power supply to the second electronic control unit is deactivated. The OFF control circuit is configured to, using the power switching circuit, switch the power supply to the second electronic control unit from the power supply state to the power cutoff state in response to receiving an instruction to shift to an OFF mode indicating switching from the high power state to the low power state. The ON control circuit is configured to, using the power switching circuit, switch the power supply to the second electronic control unit from the power cutoff state to the power supply state in response to receiving an instruction to shift to an ON mode indicating switching from the low power state to the high power state.

In the above configuration, since the OFF control circuit switches the power supply to the second electronic control unit from the power supply state to the power cutoff state when the instruction to shift to the OFF mode is received, the power consumption of the second electronic control unit can be reduced to zero. When the instruction to shift to the ON mode is received, the supply state of power to the second electronic control unit can be switched from the power cutoff state to the power supply state.

Accordingly, when the second electronic control unit operates in normal state (that is, when the second electronic control unit is operated without adding the predetermined restriction), the power required for the operation of the second electronic control unit can be properly supplied. On the other hand, for example, when there is no problem even when the operation of the second electronic control unit is restricted for a long period (that is, even when the operation of the second electronic control unit is stopped), the supply of power to the second electronic control unit can be cut off. Thus, by eliminating the dark current of the second electronic control unit, the power consumption of the network system can be effectively reduced.

Hereinafter, embodiments of the present disclosure will be described with reference to the drawings.

### 1. First Embodiment

### 1-1. Overall Configuration

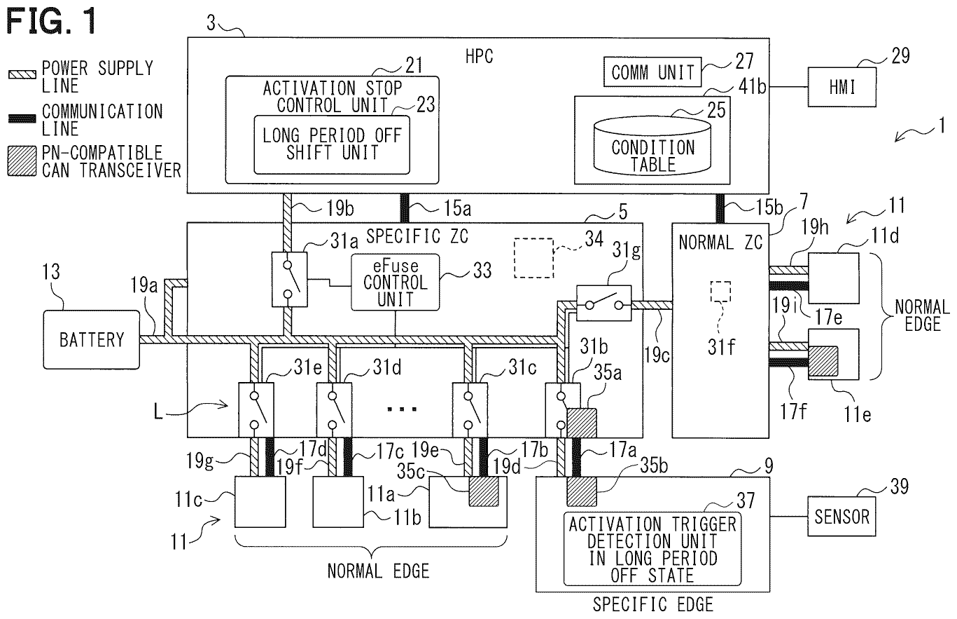

As illustrated in FIG. 1, a network system 1 according to a first embodiment is a system mounted on a vehicle such as an automobile.

The network system 1 according to the first embodiment is based on a well-known zone architecture, and uses multiple electronic control units disposed according to sections, that is, zones which are multiple areas (that is, arrangement locations in the vehicle).

The network system 1 includes at least an HPC 3, multiple hub ECUs (that is, zone ECUs) 5 and 7 communicably connected to the HPC 3, and multiple terminal ECUs 9 and 11 connected to any one of the zone ECUs 5 and 7. HPC is an abbreviation for High Performance Computing, and ECU is an abbreviation for Electronic Control Unit. The HPC 3 and each of the ECUs 5 to 11 may be referred to as a node.

Each node (that is, the HPC 3 and each of the ECUs 5 to 11) of the network system 1 is configured to operate by receiving supply of power from a battery that is the power source 13.

Specifically, as will be described later, the network system 1 can switch a supply state of power supplied from the power source 13 between a high power state and a low power state in which power lower than that in the high power state is supplied. That is, the network system 1 can switch between a high power consumption state, in which power consumption is large and which is a state corresponding to the high power state, and a low power consumption state in which power consumption is small (that is, power consumption is smaller than that in the high power consumption state) and which is a state corresponding to the low power state.

Hereinafter, the high power state (that is, the high power consumption state) may be referred to as a normal mode (that is, an ON mode), and the low power state (that is, the low power consumption state) may be referred to as a power saving mode or a long period OFF mode (that is, an OFF mode). The low power state may include, for example, a case where the power consumption is zero, as the terminal ECUs 9, 11, or the like.

Examples of the network system 1 include a well-known partial network that is a power supply control method based on communication control of a CAN protocol standard defined in ISO11898-6: 2013. CAN is an abbreviation for Controller Area Network.

In the partial network, the low power consumption state or the like is implemented by individually waking up (that is, activating) or sleeping (that is, resting) a node as necessary by referring to a communication frame. When the node wakes up, the node enters a normal operation state in which a function assigned to the node (that is, a designated function) can be available without being limited.

That is, when the node wakes up, the node is supplied with high power and enters the high power consumption state. On the other hand, when the node sleeps, the node is supplied with low power and enters the low power consumption state. That is, by sleeping, an operation state of low power consumption in which available functions are limited is set.

The HPC 3 is a high performance ECU having a function of controlling an operation of the entire network system 1 (that is, a high performance electronic control unit having a brain function).

Examples of the zone ECUs 5 and 7 include a specific ZC 5 and a normal ZC 7. As will be described later, the specific ZC 5 is an electronic control unit that performs predetermined processing or the like according to the long period OFF mode, and the normal ZC 7 is a zone ECU other than the specific ZC 5. In the following, off may be described as OFF, and on may be described as ON.

Examples of the terminal ECU 9, 11 include a specific Edge 9 and multiple normal Edges 11 (that is, normal Edges 11a, 11b, 11c, 11d, and 11e). As will be described later, the specific Edge 9 is a terminal electronic control unit that performs predetermined processing or the like related to the long period OFF mode, and the normal Edge 11 is a terminal electronic control unit other than the specific Edge 9. The terminal ECUs 9 and 11 are so-called slave ECUs controlled by the zone ECUs 5 and 7.

The HPC 3 and the specific ZC 5 are communicably connected by a first communication line 15a, and the HPC 3 and the normal ZC 7 are communicably connected by a first communication line 15b. The specific ZC 5 and the specific Edge 9 are communicably connected by a second communication line 17a, and the specific ZC 5 and each of the normal Edges 11a to 11c are communicably connected by each of second communication lines 17b, 17c, and 17d. The normal ZC 7 and the normal Edges 11d and 11e are communicably connected by second communication lines 17e and 17f.

In the first communication lines 15a and 15b and the second communication lines 17a to 17f, for example, communication by the well-known CAN is possible. In the first communication lines 15a and 15b, for example, communication by the well-known Ethernet (registered trademark) may be possible. In the second communication lines 17a to 17f, communication by the CAN may be possible.

The power source 13 is a well-known in-vehicle battery, and a high-voltage (for example, several hundred volts) battery used for a motor for vehicle traveling or another well-known low-voltage (for example, several ten volts) battery can be adopted. When the high-voltage battery is used in each device of the network system 1, a well-known DC-DC converter is used to drop the voltage to a voltage used in each device.

Power is constantly supplied from the power source 13 to the specific ZC 5 via a power supply line 19a. Power is supplied from the specific ZC 5 to the HPC 3 via a power supply line 19b, and power is supplied from the specific ZC 5 to the normal ZC 7 via a power supply line 19c. Power is supplied from the specific ZC 5 to the specific Edge 9 via a power supply line 19d. Power is supplied from the specific ZC 5 to the normal Edges 11a to 11c via power supply lines 19e, 19f, and 19g. Power is supplied from the normal ZC 7 to the normal Edges 11d and 11e via power supply lines 19h and 19i.

### 1-2. Configurations

Hereinafter, each configuration will be described in detail.

### (Configuration of HPC)

The HPC 3 functionally includes an activation stop control unit 21. The activation stop control unit 21 controls the activation (for example, an ON operation or a wake-up operation by energization) or stop (for example, an OFF operation or a sleep operation by stop of energization) of each of the Edges 9 and 11 which are control targets. The activation stop control unit 21 functionally includes a long period OFF shift unit 23. The long period OFF shift unit 23 performs control for causing the network system 1 to shift to the low power state for a long period (that is, the long period OFF mode). The long period OFF mode is a mode in which power consumption is low, which is set when the vehicle is not used for a predetermined long period, and an example thereof is a case where the vehicle is transported by a ship or the like.

The HPC 3 includes a condition table 25 in a memory 41b, which is a storage device. The condition table 25 is a table in which conditions for shifting the network system 1 to the long period OFF mode are described. For example, the condition table 25 is a condition table that defines whether the network system 1 is shifted to the long period OFF mode, a condition to be satisfied, and a method (that is, a configuration and a control method).

The HPC 3 may include a communication unit 27 capable of communicating (for example, wireless communication) with the outside (for example, cloud) of the vehicle. That is, an instruction to shift to the long period OFF mode may be input to the HPC 3 by external communication. The instruction is a long period OFF mode shift instruction set in advance for instructing to shift to the low power state for a long period equal to or longer than a predetermined period.

An HMI 29 such as an in-vehicle touch panel may be connected to the HPC 3. Therefore, for example, an instruction to shift to the long period OFF mode may be input to the HPC 3 by a human operation using the HMI 29. The HMI is an abbreviation for Human Machine Interface.

### (Configuration of Specific ZC)

As described above, the specific ZC 5 is communicably connected to the HPC 3 via the first communication line 15a, and is communicably connected to the Edges 7 and 9 via the second communication lines 17a to 17d.

The specific ZC 5 is configured to operate by constantly receiving supply of power from the power source 13, and is configured to supply power from the power source 13 to the HPC 3, the normal ZC 7, or the Edges 9 and 11.

Inside the specific ZC 5, a well-known semiconductor electronic fuse (hereinafter, referred to as eFuse) 31a that connects or disconnects a power supply line (that is, ON-OFF of power supply from the power source 13) is disposed in a path (that is, a power supply line in the specific ZC 5) for supplying power from the specific ZC 5 itself to the HPC 3. Hereinafter, a device that connects or disconnects a power supply line, such as the eFuse 31a, may be referred to as a power supply relay L. Hereinafter, ON-OFF of the power supply from the power source 13 may be simply referred to as ON-OFF of the power source.

Similarly, inside the specific ZC 5, eFuses 31b, 31c, 31d, and 31e are disposed as the power supply relays L for turning on and off the power source in the power supply lines for supplying power from the specific ZC 5 itself to the Edges 9 and 11a to 11c. The eFuse 31b is configured to turn on and off the supply of power to the specific Edge 9, the eFuse 31c is configured to turn on and off the supply of power to the normal Edge 11a, the eFuse 31d is configured to turn on and off the supply of power to the normal Edge 11b, and the eFuse 31e is configured to turn on and off the supply of power to the normal Edge 11c.

Inside the specific ZC 5, on a power supply line for supplying power from the specific ZC 5 itself to the normal ZC 7, an eFuse 31g is disposed as the power supply relay L for turning on and off the power source.

The specific ZC 5 is provided with an eFuse control unit 33 that controls ON-OFF of each of the eFuses 31a to 31e and 31g.

A configuration for switching the specific ZC 5 to sleep or wake-up will be described.

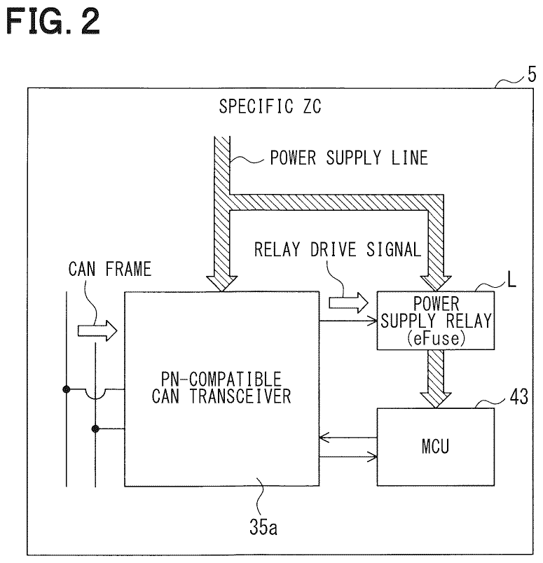

As shown in FIG. 2, the specific ZC 5 is provided with an MCU 43 that controls an operation of the specific ZC 5, a PN-compatible CAN transceiver 35a, and the eFuse 31b that is the power supply relay L. A power supply line is connected to the PN-compatible CAN transceiver 35a and the power supply relay L, power is constantly supplied to the PN-compatible CAN transceiver 35a, and power can be supplied to the MCU 43 via the power supply relay L. MCU is an abbreviation for Micro Controller Unit, and PN is an abbreviation for Partial Networking.

When the specific ZC 5 receives a CAN frame from the specific Edge 9, the specific ZC 5 outputs a relay drive signal to the power supply relay L based on information included in the CAN frame, and can control the power supply relay L to be energized (ON) or de-energized (OFF).

Each electronic control unit can selectively activate or stop a specific electronic control unit of the network by using the PN-compatible CAN transceiver. For example, when a PN-compatible CAN transceiver 35b receives an NM frame, which is a CAN frame that is activation information specifying an activation group, the specific ZC 5 is activated (that is, wake up) to the high power state. NM is an abbreviation for Network Management.

By turning on the power supply relay L, power is supplied to the MCU 43, and the specific ZC 5 can be set to the high power state (accordingly, the high power consumption state). On the other hand, by turning off the power supply relay L, the power supplied to the MCU 43 can be reduced (that is, cut off), and the specific ZC 5 can be set to the low power state (accordingly, the low power consumption state).

Although the wake-up or the like of the specific ZC 5 has been described here, the specific Edge 9 and the normal Edge 11 having the PN-compatible CAN transceiver can also function in the same manner.

As will be described later, the specific ZC 5 may be provided with a small DC-DC converter 34, which is also referred to as a power device, in order to reduce the power of the specific ZC 5 and the specific Edge 9 when the mode shifts to the long period OFF mode. By the DC-DC converter 34, it is possible to reduce the power consumption of the specific ZC 5 and the specific Edge 9 as compared with a normal state (that is, in the normal mode), which is not the long period OFF mode.

### (Configuration of Normal ZC)

Returning to FIG. 1, the normal ZC 7 is communicably connected to the HPC 3 and is communicably connected to the multiple normal Edges 11d and 11e. The normal ZC 7 is controlled by the HPC 3, and is configured to control the multiple normal Edges 11d and 11e by the normal ZC 7.

The normal ZC 7 is configured to receive the supply of power from the specific ZC 5, and to supply power from the normal ZC 7 to the normal Edges 11d and 11e.

### (Configuration of Specific Edge)

The specific Edge 9 functionally includes an activation trigger detection unit in a long period OFF state (hereinafter, referred to as an activation trigger detection unit) 37. The activation trigger detection unit 37 is configured to detect a trigger (that is, an activation trigger) for ending the long period OFF mode in the long period OFF mode. For example, a sensor 39 such as a switch that detects opening and closing of a door of the vehicle is connected to the specific Edge 9 (that is, the activation trigger detection unit 37).

The sensor 39 may be directly connected to the specific ZC 5 or may be disposed inside the specific ZC 5. In such a case, the specific ZC 5 may be provided with a function similar to that of the activation trigger detection unit 37.

For example, when the door is opened, a door signal (that is, a signal serving as an activation trigger) indicating the state is input to the activation trigger detection unit 37 from the sensor 39.

When the activation trigger is detected by the activation trigger detection unit 37, the specific Edge 9 is switched from a sleep state to a wake-up state. When the activation trigger is input to the electronic control unit such as the specific Edge 9, a configuration in which the electronic control unit is set to the wake-up state, in which a normal operation is possible, is well-known.

The specific Edge 9 is provided with the PN-compatible CAN transceiver 35b so as to be connected to the second communication line 17a. As described above, the PN-compatible CAN transceiver 35b can receive, for example, the NM frame and activate (that is, wake up) the specific Edge 9 to the high power state.

### (Configuration of Normal Edge)

The normal Edges 11a to 11c are communicably connected to the specific ZC 5 via the second communication lines 17b to 17d. The normal Edges 11d and 11e are communicably connected to the normal ZC 7 via the second communication lines 17e and 17f.

The normal Edges 11a to 11c are configured to receive the supply of power from the specific ZC 5 via the power supply lines 19e to 19g. The normal Edges 11d and 11e are configured to receive power from the normal ZC 7 via the power supply lines 19h and 19i.

CAN transceivers 35c and 35d are respectively disposed in the normal Edges 11a and 11e. Therefore, when the CAN transceivers 35c and 35d receive the NM frame from the specific ZC 5 or the normal ZC 7 that is a connection partner, the normal Edges 11a and 11e are switched from the sleep state to the wake-up state.

For the normal Edges 11b, 11c, and 11d having no PN-compatible CAN transceiver, the power supply relay L that turns on and off the power supply line can control the supply and cutoff of power according to an instruction from the specific ZC 5 or the normal ZC 7. In an Edge in which the PN-compatible CAN transceiver is included and to which power is supplied via the power supply relay L, it is possible to control both switching of the operation state by the NM frame and ON-OFF of the power source by the power supply relay L.

### (Hardware Configuration)

Regarding the network system 1, a main hardware configuration related to control will be briefly described.

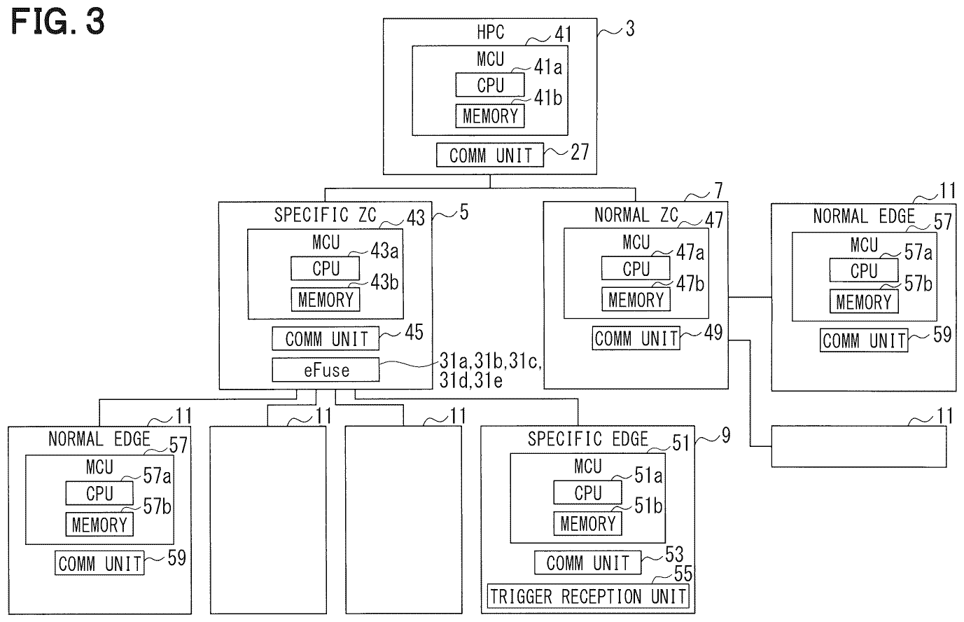

As illustrated in FIG. 3, the HPC 3 includes an MCU 41 and the communication unit 27. The MCU 41 includes a CPU 41a and a semiconductor memory (that is, a memory that is a storage device) 41b such as a ROM or a RAM.

The MCU 41 has functions of the activation stop control unit 21 and the long period OFF shift unit 23 described above.

Various functions of the MCU 41 are implemented by the CPU 41a performing a program stored in a non-transitory tangible recording medium. In this example, for example, the ROM of the memory 41b corresponds to the non-transitory tangible recording medium storing the program. A method corresponding to the program is performed by performing the program.

The number of MCUs 41 may be one or more. A method of implementing the various functions of the MCU 41 is not limited to software, and some or all of elements may be implemented by using one or more pieces of hardware. For example, when the above functions are implemented by an electronic circuit that is hardware, the electronic circuit may be implemented by a digital circuit including many logic circuits, an analog circuit, or a combination thereof.

Examples of the memory 41b include non-volatile memories such as a flash memory and an EEPROM in addition to the ROM and the RAM (hereinafter, the same applies to other ECUs). Therefore, the condition table 25 may be stored in a non-volatile memory or the like.

The specific ZC 5 includes the MCU 43, a communication unit 45, and the eFuses 31a to 31e. The MCU 43 includes a CPU 43a and a memory 43b such as a ROM or a RAM. The MCU 43 functionally includes the eFuse control unit 33 described above. Since various functions and configurations of the MCU 43 are the same as those of the MCU 41, the description thereof will be omitted. The communication unit 45 has a function of communicating with the HPC 3, the specific Edge 9, and the normal Edge 11.

The normal ZC 7 includes an MCU 47 and a communication unit 49. The MCU 47 includes a CPU 47a and a memory 47b such as a ROM or a RAM. Since various functions and configurations of the MCU 47 are the same as those of the MCU 41, the description thereof will be omitted. The communication unit 49 has a function of communicating with the HPC 3 and the normal Edge 11.

The specific Edge 9 includes an MCU 51, a communication unit 53, and a trigger reception unit 55. The MCU 51 includes a CPU 51a and a memory 51b such as a ROM or a RAM. Since various functions and configurations of the MCU 51 are the same as those of the MCU 41, the description thereof will be omitted.

The communication unit 53 has a function of communicating with the specific ZC 5. The trigger reception unit 55 has a function of receiving a signal of an activation trigger transmitted from the sensor 39.

Each normal Edge 11 includes an MCU 57 and a communication unit 59.

The MCU 57 includes a CPU 57a and a memory 57b such as a ROM or a RAM. Since various functions and configurations of the MCU 57 are the same as those of the MCU 41, the description thereof will be omitted. The communication unit 59 has a function of communicating with the specific ZC 5 or the normal ZC 7.

### 1-3. Operation

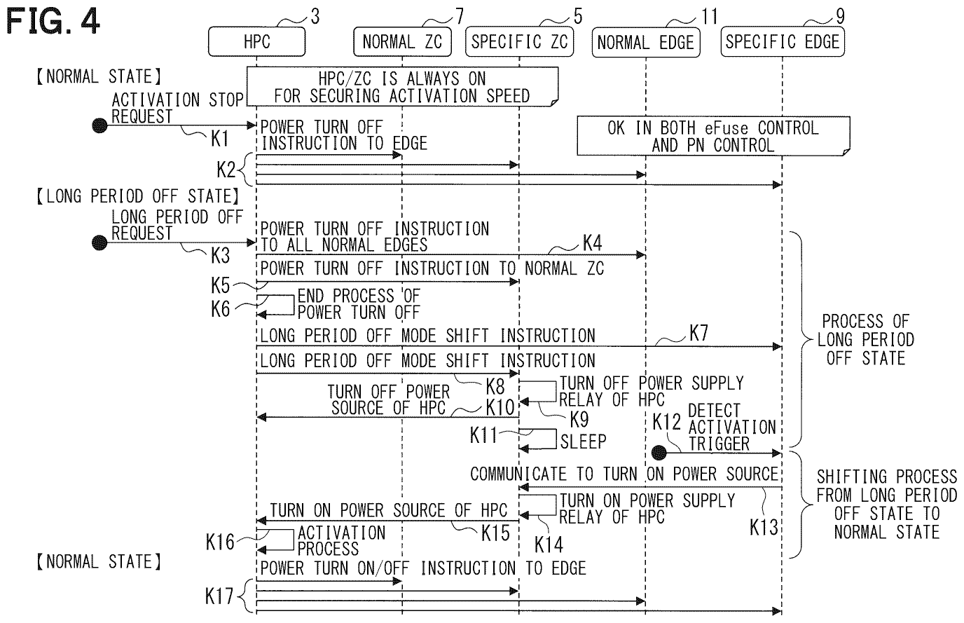

Next, the operation of the network system 1 will be described with reference to FIG. 4.

### 1-3-1. Normal State

First, in the normal state (that is, in the normal mode), which is not the long period OFF state (that is, the long period OFF mode), basically, power of a normal voltage (for example, about 12 V) is supplied from the power source 13 to the HPC 3 and each of the ZCs 5 and 7 in order to secure an activation speed. That is, the power source of the HPC 3 and each of the ZCs 5 and 7 is ON.

Next, a case where an activation stop request is issued from the HPC 3 to each of the Edges 9 and 11, which are control targets, in the normal state will be described. The activation stop request is a request to stop the activation of the Edges 9 and 11 (see step K1). Hereinafter, the description of “step” will be omitted.

Examples of the request to stop include a request to set the operation of each of the Edges 9 and 11 to an operation state (that is, low power state: sleep state) in which low power with limited available functions is consumed. Examples of the low power state include a state in which the supply of power is completely cut off, in addition to a state in which low power is supplied.

When the activation stop request is output from the HPC 3, an instruction to turn off the power source of each of the normal Edges 11 is output to the normal ZC 7 or the specific ZC 5 to which each of the normal Edges 11 that is a target of the activation stop request is connected (see K2).

Therefore, the normal ZC 7 and the specific ZC 5 that receives the activation stop request perform control for turning off the power source of each of the Edges 11.

For example, by performing control (that is, eFuse control) of opening (that is, turning off) the eFuses 31b to 31e by the eFuse control unit 33, it is possible to perform an operation of cutting off the supply of power to each of the Edges 11.

Alternatively, a certain Edge 11 may be selectively switched from the high power state to the low power state (that is, sleep) by controlling the partial network (that is, PN) described above.

On the other hand, examples of an activation request in the case of activation include a request to set the operation of each of the Edges 9 and 11 to an operation state (that is, high power state: wake-up state) in which high power without limited available functions is consumed.

When the activation request is output from the HPC 3, an instruction to turn on the power source of each of the normal Edges 11 is output to the normal ZC 7 or the specific ZC 5 to which each of the normal Edges 11 that is a target of the activation request is connected.

Therefore, the normal ZC 7 and the specific ZC 5 that receives the activation request perform control for turning on the power source of each of the Edges 11.

For example, by performing control (that is, eFuse control) of closing (that is, turning on) the eFuses 31b to 31e by the eFuse control unit 33, it is possible to perform an operation of supplying power to each of the Edges 11.

Alternatively, a certain Edge 11 may be selectively switched (that is, waked up) from the low power state to the high power state by the control of the partial network described above.

### Long Period OFF State

### (Start of Long Period OFF: When Long Period OFF Request is Issued)

Next, a case where a long period OFF request is issued by the HPC 3 in the normal mode will be described (see K3). As described above, the long period OFF request is a request for setting the network system 1 to the low power state for a long period. The request is a request of the long period OFF mode shift instruction.

First, when a long period OFF request is issued by the HPC 3, an instruction to turn off the power source of all the normal Edges 11 is sent to the specific ZC 5 and the normal ZC 7 (see K4). That is, an instruction to cut off (that is, turn off) the supply of power from the power source 13 is issued. Accordingly, when the power supply relay L such as an eFuse 31f (see FIG. 1) is disposed on a power supply line connected to each of the normal Edges 11, the power supply relay L is turned off to turn off the power source of the normal Edge 11.

Next, an instruction to turn off the power source of the normal ZC 7 is issued from the HPC 3 to the specific ZC 5 (see K5). Specifically, in the specific ZC 5, since the eFuse 31g is disposed as the power supply relay L on the power supply line that supplies power to the normal ZC 7, the power source of the normal ZC 7 can be turned off by turning off the power supply relay L by the specific ZC 5.

Next, end processing for turning off the power source of the HPC 3 is performed (see K6). This processing is well-known shutdown processing of, for example, ending an operating application or the like in advance when the power supply to the HPC 3 is cut off.

Next, the HPC 3 outputs, to the specific ZC 5, an instruction for shifting the specific Edge 9 to the long period OFF mode (that is, a long period OFF mode shift instruction) (see K7). Accordingly, the specific ZC 5 shifts the specific Edge 9 to the low power state. For example, by transmitting the NM frame from the specific ZC 5 to the specific Edge 9, the specific Edge 9 can be set to the low power state (that is, the sleep state). When the specific Edge 9 receives a signal serving as an activation trigger from the sensor 39 in the low power state as described later, the specific Edge 9 can return to the high power state. The power supply relay L of the specific Edge 9 is not turned off (that is, the supply of power is not cut off).

When the specific Edge 9 is shifted to the low power state, for example, the small DC-DC converter 34 may be used to supply power having a voltage lower than in the normal state to the specific Edge 9 (for example, the PN-compatible CAN transceiver 35b).

Next, the HPC 3 outputs, to the specific ZC 5, an instruction for shifting the HPC 3 itself and the specific ZC 5 to the long period OFF mode (that is, the long period OFF mode shift instruction) (see K8).

When the long period OFF mode shift instruction is received, the specific ZC 5 first turns off the eFuse 31a (see K9). Accordingly, since the supply of power from the power source 13 to the HPC 3 is cut off (that is, the power source of the HPC 3 is turned off), the power consumption of the HPC 3 becomes zero (see K10).

Thereafter, as shown in FIG. 2, the specific ZC 5 turns off the power supply relay L that supplies power to the MCU 43 of the specific ZC 5, and sets the specific ZC 5 to the low power state (that is, the sleep state) (see K11).

### (End of Long Period OFF: When Activation Trigger is Detected)

Next, a case where the long period OFF state is shifted to the normal state will be described.

First, for example, when the sensor 39 detects that the door of the vehicle is opened, the sensor 39 outputs a signal (that is, a trigger signal serving as an activation trigger) indicating that the door is opened to the specific Edge 9 in the sleep state.

When the trigger signal is input to the specific Edge 9, the activation trigger detection unit 37 detects the occurrence of the activation trigger, and starts the processing when shifting from the long period OFF mode to the normal mode (see K12).

Specifically, the specific Edge 9 itself is waked up. At the same time, an NM frame including information for waking up the specific ZC 5 is transmitted to the specific ZC 5 (see K13).

Next, when the specific ZC 5 receives the NM frame from the specific Edge 9, the specific ZC 5 itself is waked up. At the same time, the eFuse control unit 33 turns on the eFuse 31 (see K14) and resumes the supply of power to the HPC 3 (see K15).

Thereafter, well-known activation processing at the time of starting the operation of the HPC 3 is performed (see K16), and the control for each of the ZCs 5 and 7 and each of the Edges 9 and 11 is performed similarly to the normal mode before the long period OFF mode described above (see K17).

### 1-4. Processing

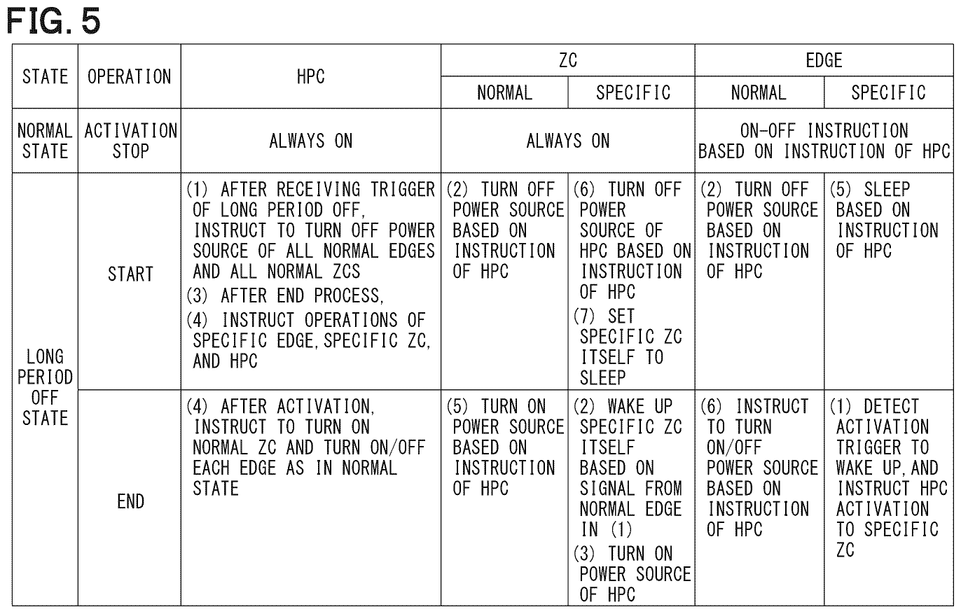

Next, main control processing performed in the network system 1 will be described with reference to FIG. 5 to FIG. 7.

As shown in FIG. 5, in the normal state (that is, in the normal mode), the power sources of the HPC 3, the normal ZC 7, and the specific ZC 5 are always turned on. The normal Edge 11 and the specific Edge 9 are turned on or off according to the instruction of the HPC 3.

(Processing when Shifting from Normal State to Long Period OFF State: Start Processing)

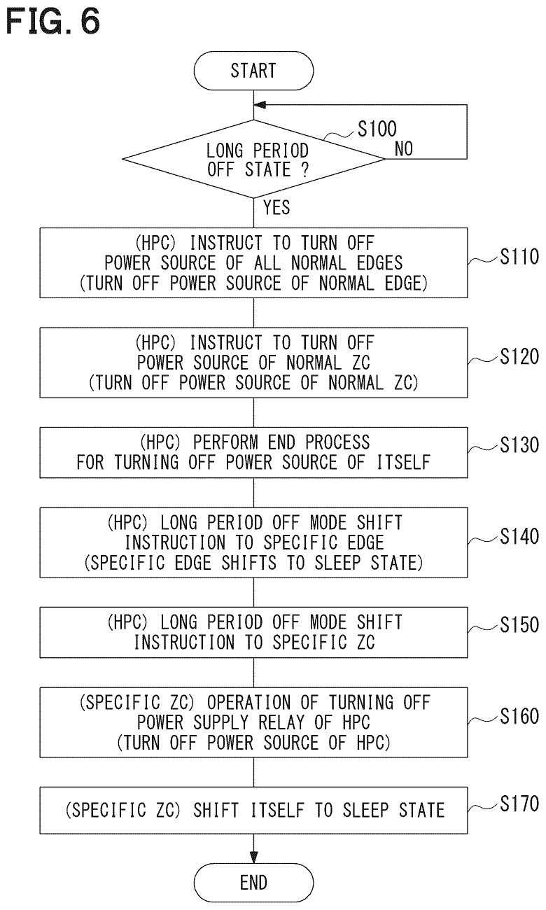

As shown in FIG. 5 and FIG. 6, in step (hereinafter referred to as S) 100, the HPC 3 determines whether an instruction is issued from an outside device or the like to shift from the normal mode to the long period OFF mode. When an affirmative determination is made, the processing proceeds to S110, and when a negative determination is made, the processing waits (that is, the normal mode is maintained).

Even when an instruction is issued to shift to the long period OFF mode, in a situation where a vehicle state cannot be shifted (for example, during traveling), a determination is made to not shift to the long period OFF mode.

In S110, the HPC 3 instructs to turn off the power source of all the normal Edges 11 (see (1) in the start of FIG. 5). Accordingly, the power source of all the normal Edges 11 is turned off (see (2) in the normal Edge of FIG. 5).

In S120, the HPC 3 instructs to turn off the power source of the normal ZC 7 (see (1) in the start of FIG. 5). Accordingly, the power source of the normal ZC 7 is turned off (see (2) in the normal ZC 7 of FIG. 5).

In S130, end processing for turning off the power source of the HPC 3 itself is performed (see (3) in FIG. 5).

In S140, the HPC 3 instructs the specific Edge 9 to shift to the long period OFF mode via the specific ZC 5 (see (4) in FIG. 5). Accordingly, the specific Edge 9 shifts to the sleep state (see (5) in FIG. 5).

In S150, the HPC 3 instructs the specific ZC 5 to shift to the long period OFF mode (see (4) in FIG. 5).

In S160, the specific ZC 5 performs processing of turning off the power supply relay L connected to the HPC 3 based on the instruction to shift to the long period OFF mode (see (6) in FIG. 5). Accordingly, the supply of power to the HPC 3 is cut off.

In S160, the specific ZC 5 shifts the specific ZC 5 itself to the sleep state based on the instruction to shift to the long period OFF mode (see (7) in FIG. 5), and temporarily ends the present processing.

(Processing when Shifting from Long Period OFF State to Normal State: End Processing)

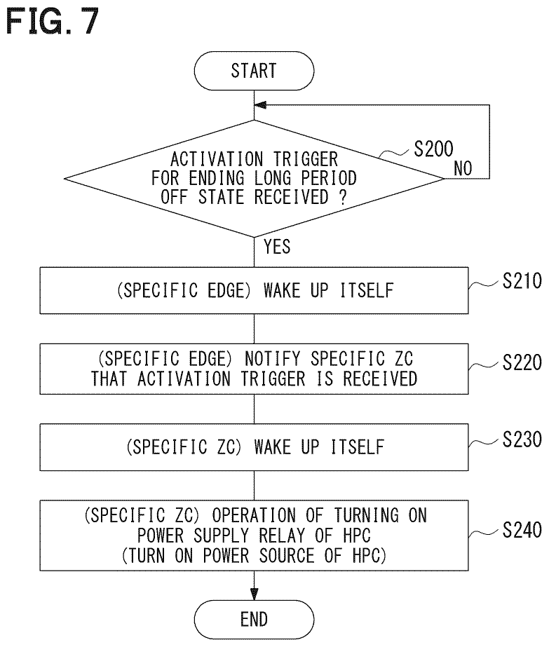

As shown in FIG. 5 and FIG. 7, in S200, when an instruction to shift from the long period OFF mode to the normal mode is issued, the processing proceeds to S210. For example, when a signal serving as an activation trigger is input from the sensor 39 to the specific Edge 9, the processing proceeds to S210. When the signal serving as the activation trigger is not input from the sensor 39 to the specific Edge 9, the long period OFF mode is maintained.

In S210, the specific Edge 9 is waked up.

In S220, the specific Edge 9 notifies the specific ZC 5 that the signal serving as the activation trigger is received (see (1) in the end of FIG. 5).

In S230, the specific ZC 5 wakes up itself and enters the high power state (see (2) in FIG. 5).

In S240, the specific ZC 5 performs processing of turning on the power supply relay L connected to the HPC 3 (see (3) in FIG. 5), and temporarily ends the present processing. Accordingly, power is supplied to the HPC 3, and thus the HPC 3 shifts to the wake-up state (that is, the high power state).

After the wake-up of the HPC 3 (that is, after the activation), the normal ZC 7 is turned on and the on-off control of the normal Edge 11 is performed as in the normal mode (see (4) to (6) in FIG. 5).

### 1-5. Effects

According to the first embodiment, the following effects can be obtained.

(1a) In the first embodiment, when an instruction to shift to the long period OFF mode is acquired, the eFuse control unit 33 switches the supply state of power to the HPC 3 from the power supply state, in which power is supplied, to the power cutoff state in which the supply of power is cut off, and thus the power consumption of the HPC 3 can be zero. When an instruction to shift to the normal mode is acquired, the supply state of power to the HPC 3 can be switched from the power cutoff state to the power supply state.

Accordingly, when the HPC 3 is operated as normal (that is, when the HPC 3 is operated without adding a predetermined restriction), the power required for the operation of the HPC 3 can be supplied. On the other hand, for example, when there is no problem even when the operation of the HPC 3 is restricted for a long period (for example, even when the operation of the HPC 3 is stopped), the power supplied to the HPC 3 can be cut off. Thus, by eliminating the dark current flowing through the HPC 3, the power consumption of the network system 1 can be reduced.

(1b) In the first embodiment, the signal obtained from the sensor 39 disposed in the vehicle can be used as a trigger signal serving as a trigger for a shift from the long period OFF mode to the normal mode.

(1c) In the first embodiment, a signal received from the HMI 29 connected to the HPC 3 or a signal transmitted from the outside of the vehicle to the communication unit 27 of the HPC 3 by wireless or the like can be used as the signal for instructing to shift from the normal mode to the long period OFF mode.

A signal other than the trigger signal obtained from the sensor 39 can be used as the signal for instructing to shift from the long period OFF mode to the normal mode. For example, a signal that functions similarly to the trigger signal may be transmitted from a communication device to the specific Edge 9 in a wireless or wired manner.

(1d) In the first embodiment, when shifting to the long period OFF mode, the DC-DC converter 34 having a power supply capability smaller than a power supply capability for supplying power in the normal mode may be used. Accordingly, the power consumption can be further reduced.

(1e) In the first embodiment, in the case of the normal mode, it is possible to supply power to the HPC 3 and the specific ZC 5 in the high power state, and to control, for each of the Edges 9 and 11, the supply state of power to be supplied to each of the Edges 9 and 11 according to the operation state of each of the Edges 9 and 11.

(1f) In the first embodiment, a communication frame (for example, the NM frame) in the CAN protocol can be used for the communication between the HPC 3 and the specific ZC 5 and/or the communication between each of the ZCs 5 and 7 and each of the Edges 9 and 11.

(1g) In the first embodiment, when shifting to the long period OFF mode, the power supplied to the normal Edge 11 can be reduced (for example, power source OFF) by the specific ZC 5 or the normal ZC 7 based on the instruction of the HPC 3.

(1h) In the first embodiment, when shifting to the long period OFF mode, the power supplied to the normal ZC 7 can be reduced (for example, power source OFF) based on the instruction of the HPC 3.

(1i) In the first embodiment, when shifting to the long period OFF mode, the power supplied to the specific Edge 9 can be reduced (for example, power source OFF) by the specific ZC 5 based on the instruction of the HPC 3.

(1j) In the first embodiment, when shifting to the long period OFF mode, after the supply of power to the normal Edge 11 is reduced, the supply of power to the HPC 3 is cut off by the specific ZC 5, and then the specific ZC 5 itself can be controlled to the low power state.

(1k) In the first embodiment, when shifting to the normal mode, it is possible to wake up the specific ZC 5, turn on the power source of the HPC 3, and then control a power state of each of the ZCs 5 and 7 and each of the Edges 9 and 11 by the HPC 3.

(1l) In the first embodiment, as an instruction to shift from the normal mode to the long period OFF mode, a specific signal for instructing to shift to the low power state for a long period equal to or longer than a predetermined period can be adopted. The specific signal can be input by the HMI 29. The specific signal can be transmitted from a device (for example, a cloud or an information terminal) outside the vehicle to the vehicle in a wireless or wired manner.

### 1-6. Correspondence Relationship

Next, a relationship between the present disclosure and the first embodiment will be described.

A network system corresponds to the network system 1, a power source corresponds to the power source 13, a terminal device (for example, a terminal electronic control unit) corresponds to the specific Edge 9, a first electronic control unit corresponds to the specific ZC 5, a second electronic control unit corresponds to the HPC 3, a power switching circuit corresponds to the eFuse 31a, an OFF control circuit corresponds to the eFuse control unit 33 and the processing of S160, and an ON control circuit corresponds to the eFuse control unit 33 and the processing of S240. A third electronic control unit corresponds to the normal ZC 7.

### 2. Second Embodiment

Since a basic configuration of a second embodiment is the same as that of the first embodiment, differences from the first embodiment will be mainly described below. The same reference numerals as those in the first embodiment indicate the same configuration, and the preceding description will be referred to.

Since the second embodiment is different from the first embodiment in the configuration of the network system, the difference will be mainly described.

The network system of the second embodiment is based on a well-known domain architecture, and uses multiple electronic control units classified into multiple domains (that is, divided for each function).

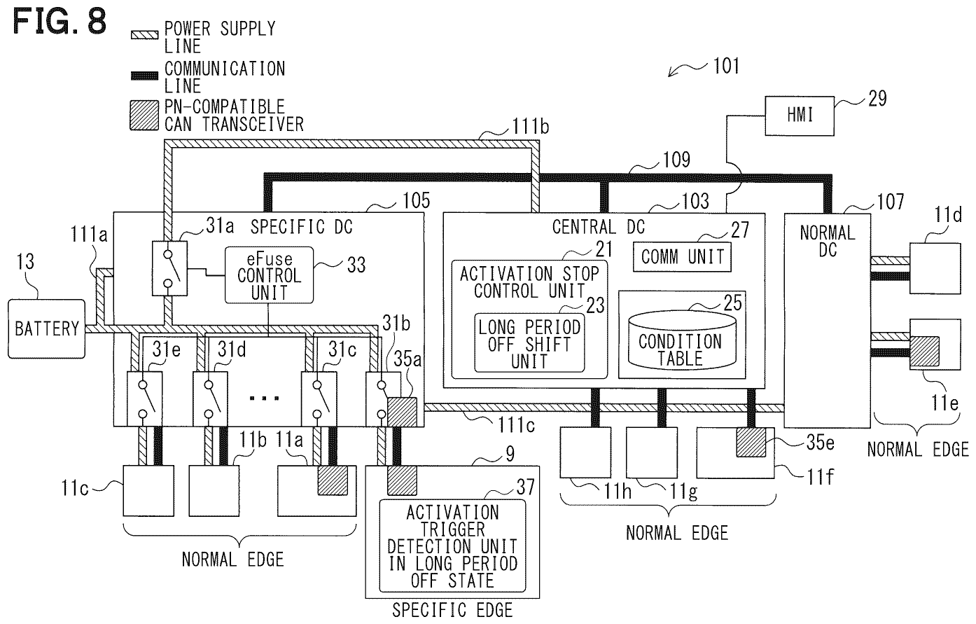

As illustrated in FIG. 8, a network system 101 includes a central DC 103 that controls an overall operation of the network system 101, and a specific DC 105 and a normal DC 107 that are communicably connected to the central DC 103. The central DC 103, the specific DC 105, and the normal DC 107 are so-called domain controllers.

The specific DC 105 has the same configuration and function as the specific ZC 5 according to the first embodiment. That is, the specific DC 105 includes the eFuse control unit 33, the eFuses 31a to 31e, the PN-compatible CAN transceiver 35a, or the like. The specific DC 105 is connected to the specific Edge 9 and the normal Edges 11a to 11c. The specific DC 105 is configured to receive the supply of power from the power source 13 via a power supply line 111a.

The normal DC 107 has the same configuration and function as the normal ZC 7 according to the first embodiment. The normal Edges 11e and 11d are connected to the normal DC 107.

The central DC 103 has the same configuration and function as the HPC 3 according to the first embodiment. That is, the central DC 103 includes the activation stop control unit 21, the condition table 25, the communication unit 27, or the like. Normal Edges 11f, 11g, and 11h are communicably connected to the central DC 103. In the normal Edge 11f, a PN-compatible CAN transceiver 35e is disposed.

The central DC 103, the specific DC 105, and the normal DC 107 are communicably connected to one another via a communication line 109.

The central DC 103 and the normal DC 107 are configured to receive the supply of power from the specific DC 105 via power supply lines 111b and 111c. The normal DC 107 may receive the supply of power from the central DC 103.

In the second embodiment, similarly to the first embodiment, it is possible to shift from the normal mode to the long period OFF mode with low power consumption based on an instruction from the central DC 103. When the signal of the activation trigger is input from the sensor 39 to the specific Edge 9, the mode can be shifted from the long period OFF mode to the normal mode.

The second embodiment has the same effect as the first embodiment.

### 3. Other Embodiments

Although the embodiments of the present disclosure are described above, it is needless to say that the present disclosure is not limited to the above-described embodiments and that various configurations can be adopted.

(3a) For example, in the case of the long period OFF mode, the power supply line can be cut off (that is, energization can be cut off) using the eFuse, but a configuration in which energization is cut off using another type of power supply relay may be adopted.

(3b) In the case of the long period OFF mode, the power supply line can be cut off using a power supply relay such as an eFuse, but a control target (for example, an electronic control unit such as each Edge or each zone ECU) by which a supply state of power is controlled using a communication unit such as a CAN frame (for example, an NM frame) may be set to a low power state (for example, a sleep state).

(3c) In the long period OFF mode, a circuit configuration may be adopted in which the supply of power to the specific Edge is cut off (that is, the power consumption is zero), and the specific Edge is waked up when a signal of an activation trigger is input from a sensor or the like to the specific Edge. That is, a relay or the like may be driven using power of the signal of the activation trigger to start the supply of power to the specific Edge.

(3d) Examples of the normal Edge electrically connected to the specific ZC and the normal ZC include an electronic control unit that functions as a so-called slave ECU, but in addition to the electronic control unit or instead of the electronic control unit, an electric device such as a sensor or an actuator operated by power supplied from the specific ZC or the normal ZC may be connected. In this case, power supply to these electric devices can be stopped by the power supply relay or the like by the specific ZC or the normal ZC in the long period OFF mode.

(3e) Operations of the network system described in the present disclosure may be implemented by a dedicated computer including a processor and a memory programmed to perform one or more functions embodied by a computer program.

Alternatively, the operations of the network system described in the present disclosure may be implemented by a dedicated computer provided by forming a processor with one or more dedicated hardware logic circuits.

Alternatively, the operations of the network system described in the present disclosure may be implemented by one or more dedicated computers implemented by a combination of a processor and a memory programmed to perform one or more functions, and a processor implemented by one or more hardware logic circuits.

The computer program may be stored in a computer-readable non-transitory tangible recording medium as an instruction to be performed by a computer.

A method for implementing the functions of the network system does not necessarily include software, and all the functions may be implemented using one or more pieces of hardware.

(3f) In addition to the network system described above, the present disclosure can be implemented in various forms such as a configuration including the network system as a component, a program for causing a computer of the network system to function, a non-transitory tangible recording medium such as a semiconductor memory in which the program is recorded, and a method of controlling the network system.

(3g) Multiple functions of one component in the above embodiments may be implemented by multiple components, and a function of one component may be implemented by multiple components. Multiple functions of multiple components may be implemented by one component, or one function implemented by multiple components may be implemented by one component. A part of the configuration of each of the embodiments described above may be omitted. At least a part of the configuration of each of the embodiments described above may be added to or substituted for a configuration of another embodiment.

What is claimed is:

1. A network system configured to switch a state of a system, which is supplied with power from a power source, between a high power state and a low power state, a power consumption in the high power state being larger than a power consumption in the low power state, the network system comprising:
a first electronic control unit communicably connected to one or more terminal devices and configured to control an operation of each terminal device; and
a second electronic control unit communicably connected to the first electronic control unit and configured to control an operation of the first electronic control unit,
wherein
the first electronic control unit includes:
a power switching circuit configured to switch a power supply to the second electronic control unit between a power supply state in which the power supply to the second electronic control unit is activated and a power cutoff state in which the power supply to the second electronic control unit is deactivated;
an off control circuit configured to, using the power switching circuit, switch the power supply to the second electronic control unit from the power supply state to the power cutoff state in response to receiving an instruction to shift to an off mode indicating switching from the high power state to the low power state; and
an on control circuit configured to, using the power switching circuit, switch the power supply to the second electronic control unit from the power cutoff state to the power supply state in response to receiving an instruction to shift to an on mode indicating switching from the low power state to the high power state.

2. The network system according to claim 1, wherein
each terminal device is implemented by a terminal electronic control unit, and
each terminal device is configured to:
detect a trigger signal serving as a trigger for the instruction to shift to the on mode from an electric device connected to the terminal electronic control unit; and
notify the first electronic control unit that the trigger signal is detected.

3. The network system according to claim 2, wherein
the first electronic control unit is a zone control device that controls operations of the one or more terminal electronic control units,
the second electronic control unit is an integrated control device that controls an operation of the network system, and
the first electronic control unit is configured to:
switch the power supply to the second electronic control unit from the power supply state to the power cutoff state by the off control circuit in response to receiving the instruction to shift to the off mode; and
switch the power supply to the second electronic control unit from the power cutoff state to the power supply state by the on control circuit in response to receiving the instruction to shift to the on mode, which is output from one of the one or more terminal electronic control units based on the trigger signal.

4. The network system according to claim 1, wherein
a signal obtained from a sensor equipped to a vehicle is used as a trigger signal that triggers a shift from the off mode to the on mode.

5. The network system according to claim 1, wherein,
when the network system shifts to the off mode, a power device having a power supply capability lower than a power supply capability of supplying the power in the on mode is used.

6. The network system according to claim 1, wherein
a signal received from an input device equipped to a vehicle or a signal acquired from an external source located outside of the network system is used as a signal for the instruction to shift from the on mode to the off mode or the instruction to shift from the off mode to the on mode.

7. The network system according to claim 1, wherein
each terminal device is implemented by a terminal electronic control unit, and
in the on mode, the first electronic control unit and the second electronic control unit are supplied with the power in the high power state and a power supply to each terminal electronic control unit is controlled according to an operation state of the corresponding terminal electronic control unit.

8. The network system according to claim 1, wherein
each terminal device is implemented by a terminal electronic control unit, and
a communication frame defined under controller area network (CAN) protocol is used for (i) a communication between the second electronic control unit and the first electronic control unit and/or (ii) a communication between the first electronic control unit and each terminal electronic control unit.

9. The network system according to claim 1, wherein
each terminal device is implemented by a terminal electronic control unit, and
when the network system shifts to the off mode, power supply to a part of the one or more terminal electronic control units, which has not received a trigger signal serving as a trigger for the instruction to shift to the on mode, is deactivated according to an instruction from the second electronic control unit.

10. The network system according to claim 1, further comprising,
a third electronic control unit that controls operations of one or more terminal electronic control units and does not include the power switching circuit,
wherein, when the network system shifts to the off mode, power supply to the third electronic control unit is deactivated according to an instruction from the second electronic control unit.

11. The network system according to claim 1, wherein
each terminal device is implemented by a terminal electronic control unit, and
when the network system shifts to the off mode, power supply to a part of the one or more terminal electronic control units, which has received a trigger signal serving as a trigger for the instruction to shift to the on mode, is switched to the low power state according to an instruction from the second electronic control unit.

12. The network system according to claim 1, wherein,
when the network system shifts to the off mode, the off control circuit of the first electronic control unit is configured to switch the power supply to the second electronic control unit from the power supply state to the power cutoff state, and then switch the first electronic control unit from the high power state to the low power state.

13. The network system according to claim 1, wherein,
when the network system shifts to the on mode, the first electronic control unit is set to the high power state.

14. The network system according to claim 13, wherein,
after the first electronic control unit is set to the high power state, the on control circuit of the first electronic control unit switches the power supply to the second electronic control unit to the power supply state.

15. The network system according to claim 1, wherein
the instruction to shift to the off mode is a long period off mode shift instruction set in advance for instructing to shift to the low power state for a long period, which is set to be equal to or longer than a predetermined period.
